(19) United States
(12) Patent Application Publication
(10) Pub. No.: US 2002/0161767 A1
(43) Pub. Date: Oct. 31, 2002

(54) System and method for updating content on a plurality of content server computers over a network

(76) Inventors: Aaron M. Shapiro, Atlanta, GA (US); Theodore John Roberts JR., Marietta, GA (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/845,465

(22) Filed: Apr. 30, 2001

(51) Int. Cl. G06F 7/00

(52) U.S. Cl. 707/9

(57) ABSTRACT

An optimally selected group of content servers on a network is selected to intelligently and efficiently handle requests for dynamically changing content. The subset or group of content servers is selected based on anticipated points of access for the content at issue. The anticipated access points may be determined based upon a variety of factors related to intended recipients of the content and/or characteristics of the content itself. Content is then loaded onto the selected content servers, which stand ready to service local requests for such content. The content may be automatically updated after a predetermined time interval. Alternatively, the content is only updated when it has been changed and new data related to the content is available. These updates may involve replacing the content or partially updating the content with only what has changed since the last update.

### FIELD OF THE INVENTION

This invention relates to systems and methods for the distributed delivery of content-rich communications and, more particularly, to systems and methods for updating content stored on selected server nodes of a distributed network of content servers.

### BACKGROUND OF THE INVENTION

The ability to remotely access a computer and the content it serves has been one of the key attributes and attractive features of the global Internet. In typical data networks, a server receives requests from users (via client or user access nodes) for the content stored and maintained on the server. In response, the server provides access to or transmits a copy of the content. Those skilled in the art will appreciate that “content” provided by a server may be any type of data, such as database records, web site hypertext markup language (HTML) files, stored digital images, or application program modules.

Much of this data is charactertistically “static” in that it does not change over long periods of time. For example, a software company may offer add-on features to their flagship word processing product in an online and downloadable application program module. The content of this program module (i.e., the add-on features) are relatively stable and do not change unless the software company provides a new revision of the module to their web server. Additionally, the software company logo displayed each time a user goes to that company's web site is stored in a graphic file that is static. The content of this file (i.e., the stylized image of the software company's logo) is traditionally not one that is often changed.

On the other hand, some content stored on networks is characteristically “dynamic” in that part of all of it changes over relatively short periods of time. An example of such dynamic content is sporting event results as the event occurs. During Major League Baseball's World Series, it is known that the score and play-by-play information is available online as each game and each inning unfolds. Interested fans can access this rapidly changing information online instead of or in conjunction with watching the game on television.

Another example of dynamic content is stock prices when the relevant market is open and trading. Complex, real-time and fault-tolerant computer systems are used to track the prices of stocks, bonds, commodities, and other financial instruments as they are traded on the appropriate exchanges. The availability of such near-real time information online has given online investors the ability to track all types of characteristic information related to financial securities and commodities simply by accessing the appropriate content on a remote computer.

A further example of dynamic content is ongoing auction information as an auction proceeds prior to and resulting in the sale of the auctioned item(s). Some types of auctions operate by providing the bidding price of the item as the price goes higher and higher until the highest bidding price wins. Other types of auctions operate by providing an asking price of the item as the price is continually lowered and quantities of the item are bought by bidders until there is nothing left. However, in all types of online auctions, there is an abundance of online content (e.g., current bidding price, current asking price, quantities left, minimum prices, etc.) that is dynamic in nature.

With both static and dynamic content, it is generally considered a good thing for users to access the content online. Indeed, most online providers of such content place the content online for such a purpose and even sell advertising space given the expected draw of the content. However, there remains the danger of overloading the server when too many requests for the content are received. In other words, when the computer server becomes overwhelmed with requests for its content, the performance of the computer server may become undesirably reduced. Indeed, in some instances, inundating the server with requests may even shut the computer server down effectively halting all responses to requests. For example, if a breaking news story hits, many users may attempt to access online news information effectively flooding the news agency's server. Additionally, if the World Series goes to a final and close game, the number of users attempting to access online play-by-play information as the final and deciding game is played may bring the server providing such content to a grinding halt leaving fans unhappy and disappointed.

This overloading problem may be exacerbated when the content is rapidly changing over a relatively short period of time. Instead of single requests from a burdensomely large number of users, the server repeatedly receives requests from these users as the users attempt to keep up with the changing content. Thus, there is a desperate need for systems and methods that attempt to help avoid server overloads, especially when the content dynamically changes over a relatively short period of time.

Increasing processing power and using fault tolerant computers as servers is one possible solution to help avoid overloading a server. Using fault tolerant computers helps by duplicating the processing capabilities, thus avoiding certain types of “server downtime”. However, using fault-tolerant systems and increasing the processing power of a server usually requires upgrades to the server hardware and/or software, entirely new and expensive computers and can be undesirably costly. Additionally, there are still many situations where the amount of requests for the content stored on a server strips the upgraded server's processing abilities.

It is known that one company, Akamai Technologies of Cambridge, Mass., has a solution for handling a large number of requests for characteristically static content. Essentially, Akamai provides a distributing caching system that off-loads static content from a provider's own server to Akamai's multiple distributed content servers on Akamai's dedicated network. These servers maintain a content provider's static content, such as the provider's company logo or other graphic images from the provider's website, in many different Akamai servers. With distributed caches of static content on a multitude of Akamai's servers, users are not logging into a single web content server causing congestion and poor interactive performance when many users attempt to access the single web content server.

In more detail, it is understood that when a user accesses the provider's website that incorporates Akamai's distributed content delivery technology, the user's request for content is redirected to a local Akamai server. It is further understood that in order to populate each server, a copy of the content must be obtained from the provider's server. If the local Akamai server determines it does not yet have a copy of the relevant content, the local Akamai server must incur an initial performance reduction to download the content from the provider's server before it can take advantage of having the content locally available to local users (i.e., off-loading requests from the local users). In other words, Akamai's system is able to gain a content delivery performance advantage only after expending the time and bandwidth penalty of initially populating its thousands of servers, which is rarely done for static content.

However, Akamai's system for staging static content on many distributed servers may become problematic when the content is dynamic. In other words, when the content changes over a relatively short period of time, the performance advantage from Akamai's distributed network of dedicated servers is lost because the content is out-of-date. This is an undesirable situation. It is clear that to deal with dynamically changing content, each of their dedicated servers would incur a significant performance penalty in time and bandwidth when responding to user requests for the content. Furthermore, the longevity of the newly downloaded version of the content may be in the order of seconds depending upon how often the content changes. Unfortunately, this may slow down apparent server performance from the user's perspective sufficiently to negatively impact user satisfaction and actually discourage users from accessing the provider's website.

Therefore, there is a need in the art for systems and methods for delivering content over a data network in a manner that avoids overload situations due to high levels of user requests while accommodating content that is dynamic, i.e., changes over a relatively short period of time.

### SUMMARY OF THE INVENTION

The present invention addresses such a need in the art for delivering content over a data network in such a way that avoids overload situations while accommodating dynamic content. In accordance with such an invention, a method for updating content on a plurality of content server computers over a network is broadly embodied and described. The method begins by selecting the content server computers based upon anticipated points of access for the content. Next, the content is loaded onto the content server computers. The method continues by periodically updating the content loaded onto the content server computers.

In another aspect of the present invention, as embodied and described herein, another method is described for updating content on a plurality of content server computers over a network. The method begins by selecting the content server computers based upon anticipated points of access for the content and loading the content onto the content server computers. The method continues by determining if new data related to the content is available. If so, then the method updates the content on each of the content server computers with the new data if the new data is available.

In another aspect of the present invention, as embodied herein, another method is described for updating content on a plurality of content server computers over a network. The method begins by receiving the content from a provider on the network and determining anticipated points of access for the content. Next, the method selects the content server computers based upon a proximity of each of the content server computers to the anticipated points of access. The method continues by loading the content onto each of the selected content server computers over the network. New data related to the content from the provider is received and then periodically transmitted to each of the selected content server computers as updates to the content in response to receiving the new data.

In another aspect of the present invention, as embodied herein, a system is described for updating content on a plurality of content server computers over a network. The system typically includes a first and second content server. The first content server is for storing and maintaining the content near a first anticipated point of access for the content. The first content server is selected from the plurality of content server computers based on a first proximity to the first anticipated point of access for the content. The second content server is for storing and maintaining the content near a second anticipated point of access for the content. The second content server is selected from the plurality of content server computers based on a second proximity to the second anticipated point of access for the content. Additionally, the first content server and the second content server are operative to respond to a user request for the content and to receive new data related to the content from a provider. The new data updates the content maintained on each of the first content server and the second content server.

In a final aspect of the present invention, as embodied herein, a computer-readable medium is described for storing instructions, which when executed perform steps for updating content on a plurality of content server computers over a network. During execution, these steps comprise receiving the content from a provider on the network, determining anticipated points of access for the content, selecting the content server computers based upon a proximity of each of the content server computers the anticipated points of access, and loading the content onto each of the selected content server computers over the network. Additionally, the steps include receiving new data related to the content from the provider and providing the new data to each of the selected content server computers as updates to the content in response to receiving the new data.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a diagram of an exemplary distributed network environment for updating a plurality of content servers consistent with an embodiment of the present invention;

FIG. 2 is a flowchart of an exemplary method for updating a plurality of content servers consistent with an embodiment of the present invention; and

FIG. 3 is a flowchart of an exemplary method for updating a plurality of content servers consistent with an alternative embodiment of the present invention.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

In general, embodiments of the present invention use an optimally selected group of distributed content servers on a network to intelligently and efficiently handle requests for dynamically changing content avoiding potential overload of the content provider's own server. The group of content servers is typically selected based on anticipated points of access for the content at issue. The anticipated access points may be selected based upon a variety of factors related to intended recipients of the content and/or characteristics of the content itself. In this manner, dynamically changing content can be proactively loaded onto the selected content servers, which stand ready to service local requests for such content. In one embodiment, the content is automatically updated after a predetermined time interval. In another embodiment, the content is only updated when it has been changed. These updates may involve replacing the content or partially updating the content with only what has changed since the last update. Finally, this method of delivering dynamic content and repeatedly updating content is advantageously accomplished without incurring the performance degradation involved with large-scale broadcasting of the content to every content server on the network.

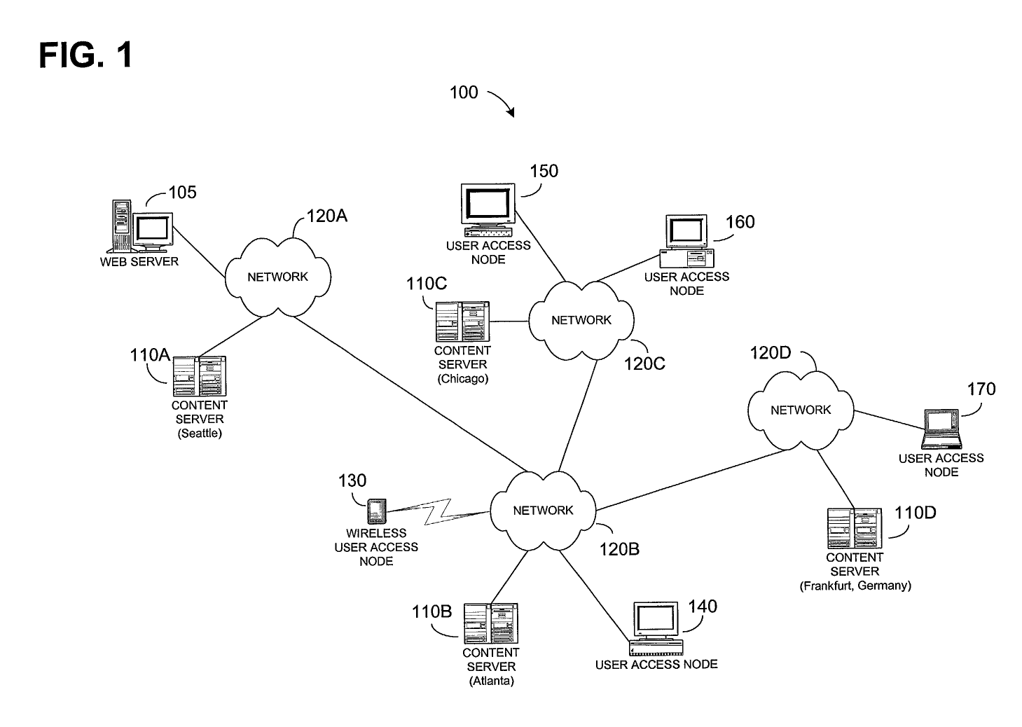

Embodiments of the present invention are further described below as part of a distributed network of interconnected computer or computing devices. Basically, FIG. 1 depicts an exemplary distributed network 100 suitable for practicing methods and implementing systems consistent with the principles of the present invention. This network 100 is deemed to be distributed in that it has processing, storage, and other functions which are handled by separate computing units (nodes) rather than by a single main computer. Those skilled in the art will realize that such a network 100 may be implemented in a variety of forms (computing elements on a simple bus structure, a local area network (LAN, a wide area network (WAN), a subnetwork that is part of a larger network, the global Internet, a broadband network with set-top communication devices, a wireless network of mobile communication devices, a combination thereof, etc.) and provides an intercommunication medium between its nodes.

Referring now to FIG. 1, exemplary network 100 is labeled as separate network segments (referred to as subnetworks 120A-120D). While each of these subnetworks are interconnected and are actually part of network 100, it is merely convenient to label them separately into subnetworks to emphasize the different geographic locations of parts of network 100. Further, while FIG. 1 shows only a limited number nodes (e.g., web servers, content servers and user access nodes) that are part of network 100, it does so for the purposes of discussion and to avoid the potential for confusion. Those skilled in the art will appreciate that network 100 may be a vast network of thousands of nodes including many more content servers than the three illustrated in FIG. 1.

Each of the subnetworks can also be considered a network by itself and may also interconnect other nodes (not shown) or other networks (not shown). In the exemplary embodiment of FIG. 1, subnetwork 120A interconnects a conventional web server node 105 and a dynamic content server 11 A, each of which are physically located in the Seattle, Wash. area. Other parts of network 100 include subnetwork 120B located in the Atlanta area, subnetwork 120C in the Chicago area and subnetwork 120D in the Frankfurt, Germany area. Subnetwork 120B interconnects another dynamic content server 110B and two user access nodes 130 and 140 in the Atlanta area. Similarly, subnetwork 120C interconnects a third dynamic content server 110C and two user access nodes 150 and 160 in the Chicago area. Further, subnetwork 120D interconnects yet another dynamic content server 110D and another user access node 170 in the Frankfurt, Germany area.

Web server node 105 is generally considered to be a network node operated by a content provider. Web server node 105 is a conventional server computer having at least a processor, memory in which to store the content (including new data as updates to the content) and run programs that service requests for the content and a communications interface to connect to network 120A. In the exemplary embodiment, web server node 105 is a server manufactured by Sun Microsystems with memory including a main memory of random access memory (RAM) and a local hard disk drive (not shown). Web server node 105 further includes a conventional Ethernet network interface card for connecting to network 100 via a gateway (not shown) from a LAN (not shown) that is part of subnetwork 120A. Typically web server node 105 maintains and stores copies of the content as it changes over time.

In the exemplary embodiment illustrated in FIG. 1, a user access node (such as user access nodes 130-170) can be used to view content (both static and dynamic in nature) by sending an appropriately formatted request to web server 105. Each user access node 130-170 is generally a network node (also called an access point) for sending content requests and receiving the requested content. While illustrated in many different implementations in FIG. 1, each user access node 130-170 has a processor, memory in which to run programs and a communications interface (e.g., network interface card, modem, IR port, etc.) to connect to network 100.

In the exemplary embodiment illustrated in FIG. 1, user access node 130 is a network node implemented in a personal digital assistant (PDA) form factor and uses a wireless connection to link into network 100 via a transceiver (not shown) that is part of subnetwork 120B. On the other hand, user access nodes 140-160 are implemented in a desktop personal computer form factor while user access node 170 is implemented as a laptop computer, each having a wired link to network 100. Those skilled in the art will appreciate that any communication device (e.g., computer, PDA, mobile radio, cellular phone, set-top receiver, etc.) that can request content from a remote server and receive such content over the network may be considered an user access node. Furthermore, those skilled in the art will understand and recognize that any given node on network 100 may have the functionality of both a web server node and an user access node.

In order to off-load the content provider's web server 105, embodiments of the present invention provide multiple content servers 110A-D. Looking at content servers 110A-110D, each is essentially a back-end server that is able to store, maintain and provide access to content within a portion of network 100. In more detail, each of the content servers 110A-110D is a node having at least one processor, memory coupled to the processor for storing content, and a communications interface allowing the processor to be coupled to or in communication with other nodes on network 100.

It is contemplated that the content server may be implemented as a single processor, a personal computer, a minicomputer, a mainframe, a multiprocessing machine, a supercomputer, or a distributed sub-network of processing devices. In the exemplary embodiment, each of the illustrated content servers 110A-110D is a group of computers designed and distributed by VA Linux Systems of Sunnyvale, Calif. Those skilled in the art will appreciate that each FullOn™ computer is a rack-mountable, dual-processor system with between 128 Mbytes and 512 Mbytes of RAM along with one or more hard drives capable of storing 8.4 Gbytes to 72.8 Gbytes of information. Each FullOn™ computer has two Pentium® III microprocessors from Intel Corporation and runs the Linux Operating System, which is considered to be result-compatible with conventional UNIX operating systems. Databases used on the content servers 110A-110D are typically implemented using standard MySQL databases. Furthermore, each FullOn™ computer has an integrated 10/100 Mbit/sec Ethernet network interface for placing its processors in communication with other nodes on the network.

Depending upon an anticipated amount of content storage space and an anticipated and desirable transactional load for the server, the size of the group of FullOn™ computers can be adjusted and then configured to operate concurrently as a single dynamic content server. Those skilled in the art will be familiar with configuring multiple computers to operate as a single server with farms of computers functioning as firewalls, database servers, proxy servers, and process load balancers. Further information on computers from VA Linux Systems, the Linux Operating System, and MySQL databases is available from a variety of commercially available printed and online sources.

Those skilled in the art will quickly recognize that a content server may be implemented in any of a variety of server and network topologies using computer hardware and software from a variety of sources. Still other embodiments consistent with the present invention may implement a content server using fault-tolerant integrated service control points within a wireless or landline advanced intelligent telecommunications network (AIN). Additionally, those skilled in the art will appreciate that while a content server may be implemented as a separate server node, it may also be incorporated into other network nodes, such as a web server or a user access node.

Referring back to FIG. 1, content is originally stored on web server 105, which normally services requests for the content. However, in order to avoid overloading web server 105 from a large number of requests for the content, the content is intelligently distributed and loaded onto several of the content servers based upon anticipated points of access for the content. Essentially, the anticipated points of access for the content is an estimate of the node location from which requests for the content will come. As will be discussed in more detail below, embodiments of the present invention determine the anticipated points of access for specific content based on factors related to intended recipients of the content (such as addresses or accessing profiles of intended recipients) as well as from characteristics of the content itself (such as language and geographic popularity of the content). Once loaded onto the appropriate content servers, a user can effectively operate one of the user access nodes (such as node 140) to submit a request for the content. The nearest content server can then provide the user with the content and with updates to the content (either full updates or partial updates with only the changes portions of the content). This effectively avoids the undesired performance degradation that comes from having to do large-scale broadcasting of content (and updates) to all content servers that would be required using prior art content delivery systems while at the same time accommodating dynamically changing content.

An exemplary embodiment of the present invention may involve a hotly contested baseball game between the Chicago Cubs and the Atlanta Braves. In this example, the popularity of the game is extremely high with the general public and especially with their fans. Web server 105 provides a web site that gives access to Major League Baseball scores, such as this baseball game, and play-by-play information as content. The scores and play-by-play information are typically updated on the web site every 30 seconds to give web site visitors (users) an interactive feel and to keep up with the game as it is played. Given the tremendous popularity of the game, the potential for overloading web server 105 also rises. Accordingly, a subset of the content servers on the network 100 is selected to handle requests for the changing play-by-play information.

This subset of content servers may be intelligently selected based on anticipated access points by intended recipients of the play-by-play information. In this example, the intended recipients are fans of the two teams. Anticipated access points for those fans may depend upon a variety of factors, such as the geographic location and/or email address of fans, accessing profiles for fans that have typically accessed web server 105 for similar games, geographic aspects of the content (e.g., home locations of the playing teams, where the game or contest is located, etc.), and determinations of geographic popularity of the content (e.g., the event is primarily popular in Southern states, the Pacific Northwest, or New York and the Northeast, etc.). Thus, a variety of historical and characteristic information related to the content and its intended recipients can be used too intelligently determine which of the content servers will be used to serve the content and off-load the provider's web server.

In this example, the content server 110C in Chicago and the content server 110B in Atlanta are advantageously loaded with scores and play-by-play information due to the geographic relationship of the content to those areas. In this manner, the anticipated high demand from those fans in those locations will be quickly and efficiently handled via their local content server. Requests from fans outside those locations can be serviced by web server 105.

Alternatively, accessing profiles on intended recipients may be maintained by a daemon or other software process related to when, where and what kind of content a user accesses on a particular server over the network. Over time, a web server or content server working on behalf of the provider can accumulate information to build an accessing profile on users that have previously requested similar content. For example, if the user is a registered participant for an online auction, that user's accessing profile may track node location, time of day, and the day of the week when the recipient accessed the web site with requests for past auction information. Likewise, it is contemplated that information may be gathered and used to build an accessing profile for particular kinds of content, such as baseball games or other sporting events. For example, if the baseball game involves the Atlanta Braves, the accessing profile for games involving this team may indicate that there are relatively large concentrations of the user requests for scores and play-by-play information from the Atlanta area and that there is a smaller, but significant concentration of user requests coming from Frankfurt, Germany. Accordingly, the anticipated access points in this example are Atlanta and Frankfurt due to a review of the appropriate accessing profile. Thus, those content servers 110B and 110D would be loaded and updated with the scores and play-by-play information.

Furthermore, a language characteristic of the content (e.g., some of the content is in the Japanese language) may be used to determine the anticipated access points for intended recipients. By scanning the content, the language characteristic can be determined. Those skilled in the art will realize that existing character encoding schemes, such as UNICODE, and efficient inline language determination methods provide the ability to make such a determination. Armed with this information, a more intelligent assessment of the anticipated access point can be made for a better determination of which content servers should be loaded with the content.

It is contemplated that factors related to the intended recipient and to the content itself can be intelligently used as factors in a variety of weighted decision systems or even using an expert or artificial intelligence system as part of the content server to make the determination of the anticipated access points leading to which of the content servers to load with the dynamic content.

Once loaded out on the select subset of content servers, dynamic content must be updated to keep it fresh and up-to-date. In the above example of a baseball game, this means that the scores and play-by-play information on the selected content servers 110B in Atlanta and 110C in Chicago should be updated. In one embodiment of the invention, updating the content is performed on a regular and periodic basis. However, other embodiments of the invention update the content as needed. In other words, the content is updated only when new data related to the content is available. The new data may be a complete replacement for the content on the content servers. Alternatively, the new data may update only a portion (e.g., just the changed part) of the content, further saving valuable time and bandwidth during the updating process.

In the exemplary embodiment, a proxy server (not shown) is disposed on each local content server. The proxy server intercepts all requests from the user access nodes to the web server 105 to see if the content server locally proximate to the requesting user can fulfill the request from local storage without having to access the content provider's own server (e.g., web server 105). The proxy server may be implemented as a conventional SQUID proxy cache available from vendors such as Pushcache.com, Inc., Austin, Tex. and Industrial Code and Logic located in Cambridge, Ontario, Canada.

If the requested content is stored locally on the content server, access to the content is quickly and efficiently provided because the content has been staged proximate to intended recipients, such as the requesting user. Otherwise, the proxy server forwards the request to the provider's own server (e.g., web server 105) where the request may also be served, albeit without the time and bandwidth advantages available with the content on the local content server.

Within the content server side, the request is received by a conventional CGI script and passed onto a content retrieval daemon. The content retrieval daemon queries and gathers the appropriate content from a content database (not shown) associated with the particular content server. For rapidly changing content, it is advantageous to store the requested content within the proxy server's local storage in a least used memory queue so that future requests may be locally served. The least used memory queue operates to keep popularly requested content while discarding and writing over less frequently requested content.

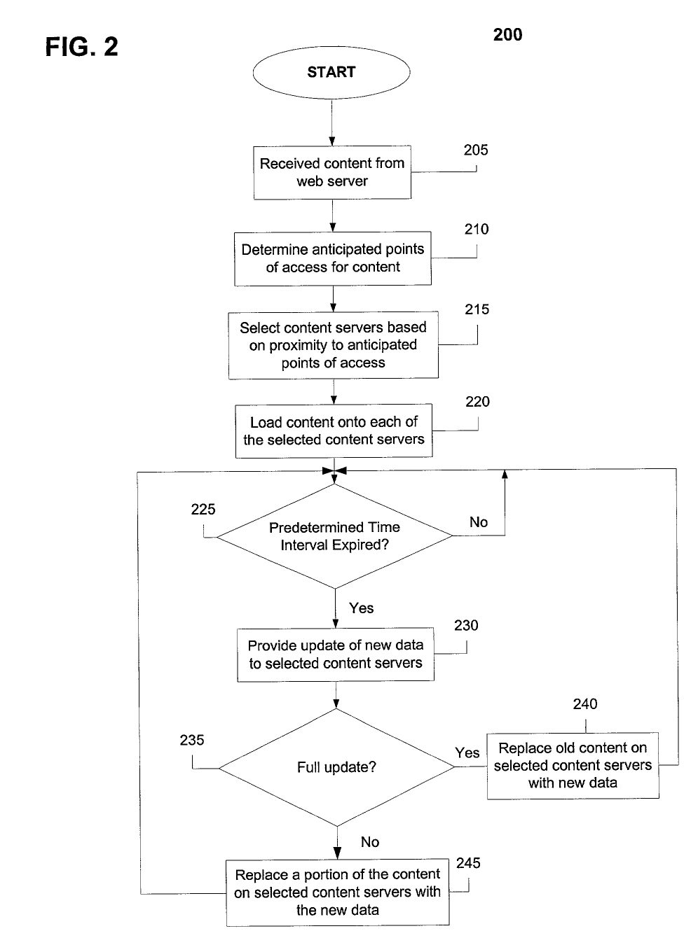

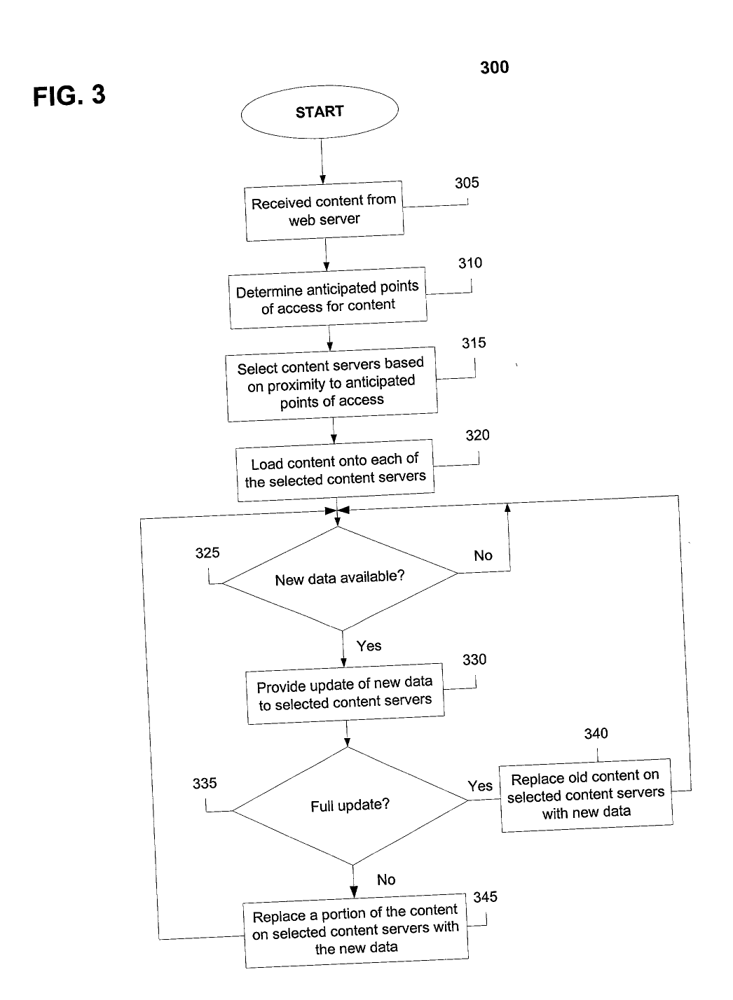

Further details on steps of exemplary methods for delivering and updating content using distributed content servers in accordance with an embodiment of the present invention will now be explained with reference to exemplary flowcharts of FIGS. 2 and 3. Referring now to the flowchart of FIG. 2, method 200 begins at step 205 where content is received from a content provider. In an exemplary embodiment, web server 105 may provide the content to one of the content servers, such as content server 110A that is proximate to web server 105. In the exemplary embodiment, content server 110A is operative via a CGI script (not shown) to receive and stage the content on other ones of the content servers so that the content is easily available to intended recipients balanced with the need to frequently update the content. Steps 210-220 essentially load the appropriate content servers while steps 225-245 involve updating the content once populated on those select servers.

At step 210, one or more anticipated points of access for the content are determined. This determination is normally based upon one or more factors related to the intended recipients for the content and/or characteristics of the content itself. These factors include an accessing profile for the intended recipient of the content. As mentioned previously, the accessing patterns of individual users may be tracked and recorded into a file. These patterns are used to build the accessing profile for the user. In an exemplary embodiment, the accessing profile is a computer-readable file that includes a user id, a user home node (i.e., the specific node that is used to store a particular user's information), and user access history. In one embodiment, the user home node information is stored on each node within the network of content servers. This is done to allow a user to actually logon from any node and then be re-directed to the correct home node for processing.

The resulting accessing profile of the user provides information that indicates (1) if the user should be considered to be an intended recipient for the content (e.g., does the user regularly hit the provider's web site and request scores and play-by-play information for several teams or just for the Atlanta Braves baseball games) and (2) when and from where does the user access the provider's content.

Another factor that may be used to determine the anticipated points of access is an accessing profile on the content. An accessing profile on the content may be built from user request information that has been historically tracked and recorded. Such a profile may identify trends in the locations of users for a particular kind of content. Again, this profile information may be used to anticipate the general geographic location from which likely user requests will come (i.e., anticipated points of access).

A geographic aspect of the content and/or an address or geographic location associated with the intended recipient may also be considered when determining the anticipated points of access for particular content. For example, when the content is scores and play-by-play information on a game, a geographic aspect of the content may be the home location of each team that is playing in the game. Other geographic aspects of the content may include the location where an event takes place or the locations of key markets for the content (e.g., Tokyo, London, and New York for the stock market).

Further, the system (e.g., scripts, daemons or other software processes on either the web server, the content servers or both) may track node locations of requesting users during the event (e.g., as the game is being played) and content is repeatedly being requested. This factor may be helpful in determining anticipated access points for existing and additional users from the location or address of the users that have already accessed the content. Thus, one embodiment is able to adjust to a change in the user request profile for a particular event as the event unfolds.

Assumptions or analytical indications about the regional or geographic popularity of specific content may further be used as a factor when determining anticipated points of access for the content. For example, ice hockey is typically popular in the Northeast part of the United States and in Canada. Such popularity indicates that if the content is scores and play-by-play information on a hockey game, the anticipated points of access for the content include the Northeast part of the United States and Canada.

Yet another factor when determining anticipated points of access is a language characteristic of the content. As mentioned before, scanning the content itself may indicate use of a particular language. As a result, the anticipated points of access may include those regional locations compatible with the particular language.

After determining one or more anticipated points based on these factors, the appropriate content servers can be selected based on a proximity to these anticipated points of access at step 215. There may be a large number of anticipated access points from the analysis performed in step 210 or there may only be a few.

When there are large numbers, is it desirable to appropriately limit the number of content servers selected in order to enhance system performance. In other words, it is desired to select enough servers to effectively off-load the provider's server (e.g., web server 105) but at the same time not select too many as to become a problem to update. Those skilled in the art will appreciate that the actual number of content servers selected will depend upon and be empirically balanced based upon at least network topology, network performance and traffic patterns, an update frequency of the content and number of users accessing the content.

In the baseball example, analysis of these factors may have indicated that the two highest anticipated points of access for this content (scores and play-by-play information) are estimated to be Atlanta and Chicago. Thus, content servers 110B and 110C are selected due to their relative physical proximity to Atlanta and Chicago.

At step 220, the content is then loaded or transmitted to the selected content servers. In the exemplary embodiment, the content temporarily received by content server 110A is then transmitted to both content servers 110B and 110C. In this manner, the content has been selectively pre-staged in locations that are anticipated hot spots for user requests.

Steps 225-245 operate to update the content that has been staged throughout network 100. In one embodiment, this updating process is automatically accomplished after a predetermined time interval. When the predetermined time interval (e.g., 30 seconds after the scores and play-by-play information was last updated) has expired or is over, step 225 proceeds to step 230. Otherwise, method 200 remains in a holding pattern in step 225 until the time interval has expired.

At step 230, new data is provided as an update for the content. In the exemplary embodiment, the provider's server (web server 105) is the source for the content and new data as updates to the content. In one embodiment, web server 105 provides the new data to content server 110A, which then distributes the new data to each of the appropriately selected content servers (e.g., content server 110B in Atlanta and content server 110C in Chicago). Alternatively, web server 105 may provide the new data directly to each of the selected content servers at the same time when updating, depending upon the load of user requests still being served by web server 105.

At step 235, a determination is made whether the new data provided is a full update. If so, then step 235 proceeds to step 240 where the old content on the selected content servers is replaced by the new data. If not, then step 235 alternatively proceeds to step 245 where only a portion of the old content on the selected content servers is replaced by the new data. This may be exceptionally helpful when part of the content remains the same (e.g., the score for the inning) but another part of the content has changed (e.g., the play-by-play information). After updating the old content in step and step 240, method 200 returns to step 225 for the next period.

While the exemplary method illustrated in FIG. 2 involves a periodic update of the content, the exemplary method illustrated in FIG. 3 involves updating only when necessary. This is often useful when the rate at which the content changes is irregular. Referring now to FIG. 3, method 300 includes steps 305-320 that are the same as steps 205-220 described above. However, at step 325, a determination is made whether new data related to the content is available. If so, then step 325 proceeds to step 330-345 similar to steps 230-245 described above. However, if not, then method 300 remains in a holding pattern waiting new data to become available

In the exemplary embodiment, content server 110A may have a CGI script that checks with web server 105 to determine if an update to the content is available. In an alternative embodiment, web server 105 has an updating script that determines if the update is available and provides the new data once available.

Other embodiments of the invention will be apparent to those skilled in the art from consideration of the specification and practice of the invention disclosed herein. Those skilled in the art will also appreciate that all or part of systems and methods consistent with the present invention may be stored on or read from other computer-readable media, such as secondary storage devices, like hard disks, floppy disks, and CD-ROM; a carrier wave received from the Internet; or other forms of computer-readable memory, such as read-only memory (ROM) or random-access memory (RAM). Although specific components of the network 100 have been described for delivering and updating dynamic content, one skilled in the art will appreciate that a system suitable for use with the exemplary embodiment may contain additional or different components, devices and program modules.

Furthermore, one skilled in the art will also realize that the software describe herein may be implemented in a variety of ways and include multiple other modules, programs, applications, scripts, processes, daemons, threads, or code sections that all functionally interrelate with each other to accomplish the collective tasks described. These modules may also be implemented using commercially available software tools, using custom object-oriented code written in the C++ programming language, using applets written in the Java programming language, or may be implemented as with discrete electrical components or as one or more custom application specific integrated circuits (ASIC) designed just for a particular purpose.

In summary, it is intended that the specification and examples be considered as exemplary. Therefore, the true scope of the invention is defined strictly by the following claims and their equivalents.

What is claimed is:

1. A method for updating content on a plurality of content server computers over a network, comprising:
selecting the content server computers based upon anticipated points of access for the content;
loading the content onto the content server computers; and
periodically updating the content loaded onto the content server computers.

2. The method of claim 1, wherein the step of periodically updating further comprises updating each of the content server computers with new data after a predetermined interval.

3. The method of claim 2, wherein the new data replaces the content.

4. The method of claim 2, wherein the new data replaces a portion of the content.

5. The method of claim 1, wherein the step of periodically updating further comprises determining if new data related to the content is available after a predetermined interval and updating each of the content server computers with the new data if it is determined that the new data is available.

6. The method of claim 5, wherein the new data replaces the content.

7. The method of claim 5, wherein the new data replaces a portion of the content.

8. The method of claim 1, wherein the step of selecting the content server computers further comprises:
determining the anticipated points of access for the content based upon a factor related to intended recipients of the content; and
selecting the content server computers based upon a proximity of the content server computers to the anticipated points of access.

9. The method of claim 8, wherein the factor comprises an accessing profile, for each of the intended recipients.

10. The method of claim 8, wherein the factor comprises an address for each of the intended recipients.

11. The method of claim 1, wherein the step of selecting the content server computers further comprises:
determining the anticipated points of access for the content based upon a geographical aspect of the content; and
selecting the content server computers based upon the proximity of the content sever computers to the anticipated points of access.

12. The method of claim 11, wherein the geographical aspect of the content is a geographic popularity determination regarding the content.

13. A method for updating content on a plurality of content server computers over a network, comprising:
selecting the content server computers based upon anticipated points of access for the content;
loading the content onto the content server computers;
determining if new data related to the content is available; and
updating the content on each of the content server computers with the new data if the new data is available.

14. The method of claim 13, wherein the step of determining further comprises determining if the new data is available after a predetermined interval.

15. The method of claim 13, wherein the new data replaces the content.

16. The method of claim 13, wherein the new data replaces a portion of the content.

17. The method of claim 13, wherein the step of selecting the content server computers further comprises:
determining the anticipated points of access for the content based upon a factor related to intended recipients of the content; and
selecting the content server computers based upon a proximity of the content server computers to the anticipated points of access.

18. The method of claim 17, wherein the factor comprises an accessing profile for each of the intended recipients.

19. The method of claim 17, wherein the factor comprises an address for each of the intended recipients.

20. The method of claim 13, wherein the step of selecting the content server computers further comprises:
determining the anticipated points of access for the content based upon a geographical aspect of the content; and
selecting the content server computers based upon the proximity of the content server computers to the anticipated points of access.

21. The method of claim 20, wherein the geographical aspect of the content is a geographic popularity determination regarding the content.

22. A method for updating content on a plurality of content server computers over a network, comprising:
receiving the content from a provider on the network;
determining anticipated points of access for the content;
selecting the content server computers based upon a proximity of each of the content server computers to the anticipated points of access;
loading the content onto each of the selected content server computers over the network
receiving new data related to the content from the provider; and
periodically transmitting the new data to each of the selected content server computers as updates to the content in response to receiving the new data.

23. The method of claim 22, wherein the new data replaces the content.

24. The method of claim 22, wherein the new data is a partial update to the content.

25. The method of claim 22 further comprising determining if the new data related to the content is available from the provider and updating each of the content server computers only if the new data is available.

26. The method of claim 25, wherein the new data replaces the content.

27. The method of claim 25, wherein the new data replaces a portion of the content.

28. The method of claim 22, wherein the determining step further comprises determining the anticipated points of access for the content based upon a factor related to intended recipients of the content.

29. The method of claim 28, wherein the determining step further comprises determining the anticipated points of access for the content by analyzing an accessing profile for each of the intended recipients of the content.

30. The method of claim 28, wherein the determining step further comprises determining the anticipated points of access for the content by analyzing an address for each of the intended recipients.

31. The method of claim 22, wherein the determining step further comprises determining the anticipated points of access for the content based upon a geographical aspect of the content.

32. The method of claim 31, wherein the geographical aspect of the content is a geographic popularity determination regarding the content.

33. A system for updating content on a plurality of content server computers over a network, comprising:
a first content server for storing and maintaining the content near a first anticipated point of access for the content, the first content server being selected from the plurality of content server computers based on a first proximity to the first anticipated point of access for the content; and
a second content server for storing and maintaining the content near a second anticipated point of access for the content, the second content server being selected from the plurality of content server computers based on a second proximity to the second anticipated point of access for the content;
wherein the first content server and the second content server being operative to respond to a user request for the content and to receive new data related to the content from a provider, the new data updating the content maintained on each of the first content server and the second content server.

34. The system of claim 33, wherein the new data replaces the content.

35. The system of claim 33, wherein the new data is a partial update to the content.

36. A computer-readable medium for storing instructions, which when executed perform steps for updating content on a plurality of content server computers over a network, comprising:
receiving the content from a provider on the network;
determining anticipated points of access for the content;
selecting the content server computers based upon a proximity of each of the content server computers to the anticipated points of access;
loading the content onto each of the selected content server computers over the network;
receiving new data related to the content from the provider; and
providing the new data to each of the selected content server computers as updates to the content in response to receiving the new data.

37. The computer readable medium of claim 36, wherein the new data replaces the content.

38. The computer readable medium of claim 36, wherein the new data is a partial update to the content.

39. The computer readable medium of claim 36 further comprising determining if the new data related to the content is available from the provider and updating each of the content server computers only if the new data is available.

40. The computer readable medium of claim 39, wherein the new data replaces the content.

41. The computer readable medium of claim 39, wherein the new data replaces a portion of the content.

42. The computer readable medium of claim 36, wherein the determining step further comprises determining the anticipated points of access for the content based upon a factor related to intended recipients of the content.

43. The computer readable medium of claim 42, wherein the determining step further comprises determining the anticipated points of access for the content by analyzing an accessing profile for each of the intended recipients of the content.

44. The computer readable medium of claim 42, wherein the determining step further comprises determining the anticipated points of access for the content by analyzing an address for each of the intended recipients.

45. The computer readable medium of claim 36, wherein the determining step further comprises determining the anticipated points of access for the content based upon a geographical aspect of the content.

46. The computer readable medium of claim 45, wherein the geographical aspect of the content is a geographic popularity determination regarding the content.
